(19) United States
(12) Patent Application Publication
(10) Pub. No.: US 2019/0374019 A1
(43) Pub. Date: Dec. 12, 2019

(54) TOOTH BRUSHING MOTION SENSING MODULE

(71) Applicant: WESH LTD., New Taipei City (TW)

(72) Inventor: CHAO-HUA LIN, New Taipei City (TW)

(21) Appl. No.: 16/186,189

(22) Filed: Nov. 9, 2018

(30) Foreign Application Priority Data
Jun. 8, 2018 (TW) 107119741

(51) Int. Cl. A46B 15/00; G01P 1/07; G09B 19/00

(52) U.S. Cl. CPC A46B 15/0044; G01P 1/07; A46B 15/004; H04W 84/12; G09B 19/0084; A46B 15/0022; A46B 2200/1066; A46B 15/0006

(57) ABSTRACT

A sensing module of tooth brushing motion is disclosed. The sensing module comprises a motion sensor and a display. The motion sensor detects the tooth brushing motion of a user and transmits a motion signal to the display. The display visualizes the tooth brushing motion and guides the tooth brushing motion for the user by playing a video or an audio. The motion sensor connects to the first magnetic unit of the display detachably by a second magnetic unit. The motion sensor transmits the motion signal to the display through a wireless radio frequency antenna, and the display receives the motion signal by a wireless radio frequency receiver.

### TECHNICAL FIELD

The present invention relates to a sensing of tooth brushing motion, particularly, to a sensing module of tooth brushing motion which can serve as a feedback system for sensing tooth brushing.

### BACKGROUND OF RELATED ARTS

The awareness of health care has been gradually enhanced by public. Oral health was easily neglected in the past. However, in recent years, the relationship between oral diseases and the other chronic diseases have been gradually emphasized. Oral health care has become an important topic of life.

Dental caries and periodontal diseases are the most prevalent diseases in oral diseases. Dental caries are the common diseases affecting the oral health of school-age children. They not only cause fever and pain, but also cause hidden worries for the health of the teeth in adulthood. Periodontal disease is becoming an increasing problem among older people, resulting in an increase of mortality.

At present time, there are many electric toothbrushes and dental flushers, providing people with very convenient oral cleaning tools. However, there are still quite a lot of users taking traditional toothbrushes for oral cleaning. It is a field worth exploring how to create a set of effective guidance tool and get feedback from the status of brushing teeth for providing users to use traditional toothbrushes.

### SUMMARY

To resolve the drawbacks of the prior arts, the present invention discloses a sensing module of tooth brushing motion, comprising: a display device, which includes a power supply, a first circuit board coupled to the power supply, a power module coupled to the first circuit board, wherein the power module includes a first magnetic attraction element and a microcontroller coupled to the first circuit board, a wireless radio frequency receiver, a display screen and a speaker; and a motion sensor detachably mounted on a toothbrush handle or the display device, wherein the motion sensor includes an electric power storage device, a second circuit board coupled to the electric power storage device, a timer, a movement sensing device and a wireless radio frequency antenna, and an electric power receiving module coupled to the second circuit board, wherein the electric power receiving module includes a second magnetic attraction element detachably connected to the first magnetic attraction element, so that the electric power receiving module is electrically connected to the power supply module for the motion sensor transmitting a motion sensing signal to the display device by the wireless radio frequency antenna, and the display device receiving the motion sensing signal by the wireless radio frequency receiver.

Embodiments of the invention are illustrated by way of example, and not by way of limitation, in the figures of the accompanying drawings in which like reference numerals refer to similar elements:

### BRIEF DESCRIPTION OF THE DRAWINGS

FIG. 1 is a schematic diagram of a display of an embodiment of the present invention.

FIG. 2 is a schematic diagram of a motion sensor of another embodiment of the present invention.

### DETAILED DESCRIPTION OF THE INVENTION

In order to understand the technical features and practical efficacy of the present invention and to implement it in accordance with the contents of the specification, hereinafter, preferred embodiments of the present invention will be described in detail with reference to the accompanying drawings.

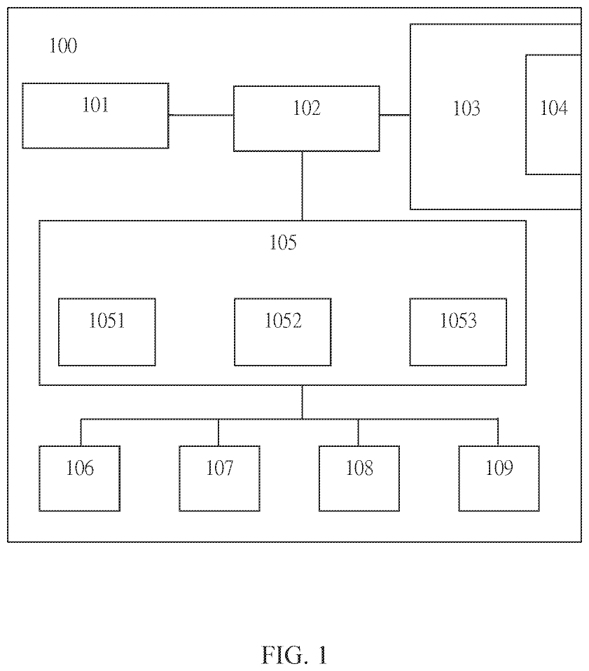

Referring to FIG. 1, it shows a schematic diagram of a display device in accordance with one embodiment of the present invention. As shown in FIG. 1, the display device 100 of the present embodiment includes a power supply 101, a first circuit board 102, a power module 103 having a first magnetic attraction element 104; and a microcontroller 105. The first circuit board 102 is electrically connected to the power supply 101. The power module 103 is electrically connected to the first circuit board 102. The microcontroller 105 is electrically connected (coupled) to the first circuit board 102, a radio frequency receiver 106, a display screen 107, a light emitting element 108 and a speaker 109.

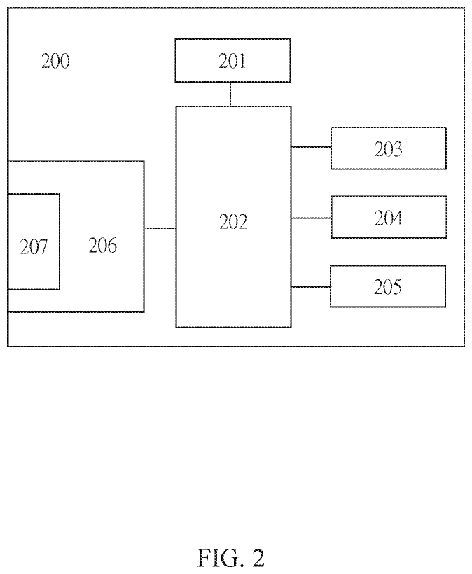

Next, referring to FIG. 2, it shows a schematic diagram of the motion sensor of the embodiment of the invention. As shown in FIG. 2, the motion sensor 200 includes an electric power storage device 201, a second circuit board 202 and an electric power receiving module 206 having a second magnetic attraction element 207. The second circuit board 202 is electrically connected (coupled) to the electric power storage device 201, a timer 203, a movement sensing device 204, and a wireless radio frequency antenna 205, respectively. The electric power receiving module 206 is electrically connected to the second circuit board 202, and the second magnetic attraction element 207 is detachably connected to the first magnetic attraction element 104, so that the electric power receiving module 206 is electrically connected to the power supply module 103. The motion sensor 200 transmits a motion sensing signal to the display device 100 by the radio frequency antenna 205, and the display device 100 receives the motion sensing signal by the wireless radio frequency receiver 106. In addition, the motion sensor 200 may be detachably mounted on a toothbrush handle or a display device 100.

In another embodiment of the present invention, the movement sensing device 204 is a gyroscope, a triaxial accelerometer, or the combination thereof. The motion sensor 200 senses the direction and movement of the user's toothbrush by the movement sensing device 204, and the time interval information of tooth brushing is obtained by the timer 203 as the motion sensing signal to monitor motion of tooth brushing. When the related information of tooth brushing is obtained by the movement sensing device 204 and the timer 203, the motion sensor 200 wirelessly transmits the motion sensing signal corresponding to the related information by the wireless radio frequency antenna 205. In one embodiment, the movement sensing device 204 includes a gyroscope and a triaxial accelerometer to improve the accuracy of tooth brushing motion sensing.

In some embodiments of the present invention, the electric power storage device 201 is a supercapacitor. In other embodiments, the electric power storage device 201 is a button-type cell battery, a cylindrical cell battery, a pin-type cell battery or the combination thereof. In other embodiments, the length of one longest side of the electric power storage device 201 is 5.8-30.2 centimeter (cm), or the electric power storage device 201 is a disc-shaped structure with the radius of 2.9-6.0 cm. For example, the electric power storage device 201 can be a button-type cell rechargeable battery with a diameter of 5.8-12.0 cm. The electric power storage device 201 can also be a cylindrical cell rechargeable battery with a height of 5.8-30.2 cm, such as a No. 5 rechargeable battery. In other embodiments, the electric power storage device 201 is a cylindrical pin-type cell battery. In some embodiments, the electric power storage device 201 is a lithium battery, a lithium-ion polymer battery, or a nickel-hydrogen battery.

In an embodiment of the invention, the microcontroller 105 further comprises an operation module 1051, a comparison module 1052, and a tooth brushing model storage medium 1053, wherein the tooth brushing model storage medium 1053 is a memory built-in an algorithm of Bass technique of tooth brushing, and the built-in tooth brushing model of Bass technique of tooth brushing is shown in Table 1.

TABLE 1
The first step: brushing upper teeth

| | | |
|---|---|---|
| 1-1 | (Start on the right side) | The toothbrush is in 45 to 60 degrees at the |
| | Brushing the right molar at | junction between tooth and gum. The |
| | cheek site | toothbrush covers part of the gum, brushing |
| | | teeth by two in order back and forth. |
| 1-2 | (Brush handle is rotating | The toothbrush is in 45 to 60 degrees at the |
| | but not changing hands.) | junction between tooth and gum. The |
| | Brushing incisor at | toothbrush covers part of the gum, brushing |
| | cheek site | teeth by two in order back and forth. |
| 1-3 | Brushing the left molar at | The toothbrush is in 45 to 60 degrees at the |
| | cheek site | junction between tooth and gum. The |
| | | toothbrush covers part of the gum, brushing |
| | | teeth by two in order back and forth. |
| 1-4 | (Brush handle is rotating | brushing teeth by two in order back and forth |
| | but not changing hands.) | |
| | Brushing the left molar at | |
| | occlusion site | |
| 1-5 | Brushing the left molar at | The toothbrush is in 45 to 60 degrees at the |
| | tongue site | junction between tooth and gum. The |
| | | toothbrush covers part of the gum, brushing |
| | | teeth by two in order back and forth. |
| 1-6 | Brushing incisor at | The toothbrush is in 45 to 60 degrees at the |
| | tongue site | junction between tooth and gum. The |
| | | toothbrush covers part of the gum, brushing |
| | | teeth by two in order back and forth. |
| 1-7 | (Changing to left hand) | The toothbrush is in 45 to 60 degrees at the |
| | Brushing the right molar at | junction between tooth and gum. The |
| | tongue site | toothbrush covers part of the gum, brushing |
| | | teeth by two in order back and forth. |
| 1-8 | Brushing the right molar at | brushing teeth by two in order back and forth |
| | occlusion site | |
| | (Finished on the right side) | |

The second steps: brushing lower teeth

| | | |
|---|---|---|
| 2-1 | (Start on the right side) | The toothbrush is in 45 to 60 degrees at the |
| | Brushing the right molar at | junction between tooth and gum. The |
| | cheek site | toothbrush covers part of the gum, brushing |
| | | teeth by two in order back and forth. |
| 2-2 | (Brush handle is rotating | The toothbrush is in 45 to 60 degrees at the |
| | but not changing hands.) | junction between tooth and gum. The |
| | Brushing incisor at | toothbrush covers part of the gum, brushing |
| | cheek site | teeth by two in order back and forth. |
| 2-3 | Brushing the left molar at | The toothbrush is in 45 to 60 degrees at the |
| | cheek site | junction between tooth and gum. The |
| | | toothbrush covers part of the gum, brushing |
| | | teeth by two in order back and forth. |
| 2-4 | Brushing the left molar at | brushing teeth by two in order back and forth |
| | occlusion site | |
| 2-5 | (Brush handle is rotating | The toothbrush is in 45 to 60 degrees at the |
| | but not changing hands.) | junction between tooth and gum. The |
| | Brushing the left molar at | toothbrush covers part of the gum, brushing |
| | tongue site | teeth by two in order back and forth. |
| 2-6 | Brushing incisor at | The toothbrush is in 45 to 60 degrees at the |
| | tongue site | junction between tooth and gum. The |
| | | toothbrush covers part of the gum, brushing |
| | | teeth by two in order back and forth. |
| 2-7 | (Changing to left hand) | The toothbrush is in 45 to 60 degrees at the |
| | Brushing the right molar at | junction between tooth and gum. The |
| | tongue site | toothbrush covers part of the gum, brushing |
| | | teeth by two in order back and forth. |
| 2-8 | Brushing the right molar at | brushing teeth by two in order back and forth |
| | occlusion site | |
| | (Finished on the right side) | |

When a user uses a toothbrush with a motion sensor 200 to brush his teeth, the motion sensor 200 senses tooth brushing action and transmits the motion sensing signal to the display device 100. The display device 100 can also include a light emitting element 108, a display screen 107, and a speaker 109. The display device 200 can display a corresponding tooth brushing model on the display screen 107 based-on the built-in data of the tooth brushing model storage medium, and guide tooth brushing by light and/or sound. Optimally, the light emitting element 108 has two light-emitting diodes that emit different bands of color light, which indicates a reminder of the power shortage of the motion sensor 200 and an indication of tooth brushing, respectively. The motion sensor 200 of the invention has the waterproof grade of IPx6 stipulated in the International Protection Marking (IEC 60529), which can block high pressure water column, and the display device 100 has the waterproof grade of IPx4, which can prevent any angle of water splashing and protect the components in the tooth brushing motion sensing module from being splashed or affected by water column or spray.

In this embodiment, the power supply 101 is a zinc-manganese battery, an alkaline battery, a nickel-cadmium battery, a lithium battery, a lithium-iron battery, an aluminum battery or the combination thereof, for supplying power source to the display device 100. In some embodiments, the motion sensor 200 is detachably mounted on a toothbrush handle or the display device 100. Preferably, the motion sensor 200 is detachably connected to the first magnetic attraction element 104 of the display device 100 by the second magnetic attraction element 207, and the motion sensor 200 transmits a motion sensing signal to the display device 100 by the wireless radio frequency antenna 205. Transfer to display device 100. In one embodiment, the wireless radio frequency antenna 205 emits a radio signal with a frequency of 2.4 gigahertz (GHz) to transmit a motion sensing signal to the display device 100. In addition, when the user does not use the toothbrush, the toothbrush can be attached to the first magnetic attraction element 104 of the display device 100 by the second magnetic attraction element 207 on the motion sensor 200 connected to the toothbrush such that the power receiving module 206 is electrically connected to the power supply module 103 by the first magnetic attraction element 104 connected to the second magnetic attraction element 207 for charging to the motion sensor 200. The motion sensor 200 stores the charged power into the electric power storage device 201 for reservation. In one embodiment, the electric power storage device 201 is a supercapacitor. When the user does not use the toothbrush, the display device 100 charges to the motion sensor 200 and the motion sensor 200 stores the charged power into the supercapacitor. When the user wants to brush his teeth, the toothbrush and the motion sensor 200 are removed from the display device 100. At this time, the motion sensor 200 uses the stored power of the supercapacitor during operating. The power stored in the supercapacitor is sufficient for the user to brush his teeth at a time. In an embodiment, the first magnetic attraction element 104 and the second magnetic attraction element 207 have an elliptical structure by which the power receiving module is electrically connected to the power supply module.

In one embodiment of the invention, the display device 100 can wirelessly transmit the motion sensing signal and the charging signal with a plurality of motion sensors 200. The user only needs to set up a display device 100 on one place, and other family members can operate their toothbrushes and motion sensors 200. In another embodiment, the motion sensor 200 can wirelessly transmit motion sensing signals and charging signals with multiple display devices 100. The user can set up a plural of display devices 100 on multiple locations, and the user can operate by a toothbrush and a motion sensor 200 in these locations. In the above embodiments, the motion sensor 200 further includes an identification module connected to the wireless radio frequency antenna 205, and the microcontroller 105 includes a matching module. The motion sensor 200 and the display device 100 can identify, match and transmit tooth brushing motion and sensing signal by the identification module and the matching module. In a preferred embodiment, the identification module includes a set of identification codes, and the matching module is an identification code matching circuit. In addition, the motion sensor 200 is detachably mounted onto the toothbrush handle to facilitate the replacement of the toothbrush by the user.

In some embodiments, the display device 100 further comprises a wireless transmission module coupled to the microcontroller 105. The wireless transmission module is a bluetooth module or a Wi-Fi module, which can transmit the motion sensing signal received by the display device 100 to an external device, such as a mobile device or a personal computer, and the motion sensing signals are then analyzed and documented so that users can analyze their brushing behaviors and correct them.

Based-on the toothbrushing motion sensing module of the invention, the user can use suitable toothbrush to guide the tooth brushing and tooth cleaning, and get the feedback of the tooth brushing condition, so as to cultivate the correct tooth brushing habit and avoid the occurrence of oral diseases.

As is understood by a person skilled in the art, the foregoing preferred embodiments of the present invention are illustrated of the present invention rather than limiting of the present invention. It is intended to cover various modifications and similar arrangements included within the spirit and scope of the appended claims, the scope of which should be accorded the broadest interpretation so as to encompass all such modifications and similar structure. While the preferred embodiment of the invention has been illustrated and described, it will be appreciated that various changes can be made therein without departing from the spirit and scope of the invention.

What is claimed is:

1. A sensing module of tooth brushing motion, comprising:
a display device, which includes a power supply, a first circuit board coupled to said power supply, a power module coupled to said first circuit board, wherein said power module includes a first magnetic attraction element and a microcontroller coupled to said first circuit board, a wireless radio frequency receiver, a display screen and a speaker; and
a motion sensor detachably mounted on a toothbrush handle or said display device, wherein said motion sensor includes an electric power storage device, a second circuit board coupled to said electric power storage device, a timer, a movement sensing device and a wireless radio frequency antenna, and an electric power receiving module coupled to said second circuit board, wherein said electric power receiving module includes a second magnetic attraction element detachably connected to said first magnetic attraction element, so that said electric power receiving module is electrically connected to said power supply module for said motion sensor transmitting a motion sensing signal to said display device by said wireless radio frequency antenna, and said display device receiving said the motion sensing signal by said wireless radio frequency receiver.

2. The sensing module of claim 1, wherein said movement sensing device is a gyroscope, a triaxial accelerometer, or the combination thereof.

3. The sensing module of claim 1, wherein said electric power storage device is a supercapacitor.

4. The sensing module of claim 1, wherein said electric power storage device is a button-type cell battery, a cylindrical cell battery, a pin-type cell battery or combinations thereof.

5. The sensing module of claim 1, wherein said electric power storage device is a disc-shaped structure with the radius of 2.9-6.0 centimeter.

6. The sensing module of claim 1, wherein said microcontroller includes an operation module, a comparison module and a tooth brushing model storage medium.

7. The sensing module of claim 6, wherein said motion sensor further includes an identification module coupled to said wireless radio frequency antenna, and said microcontroller includes a matching module.

8. The sensing module of claim 1, wherein said power supply is a zinc-manganese battery, an alkaline battery, a nickel-cadmium battery, a lithium battery, a lithium-iron battery, or an aluminum battery.

9. The sensing module of claim 1, wherein said display device further includes a wireless transmission module coupled to said microcontroller, wherein said wireless transmission module is a bluetooth module or a Wi-Fi module.

10. The sensing module of claim 1, wherein said first magnetic attraction element and said second magnetic attraction element have an elliptical structure by which said power receiving module is electrically connected to said power supply module.
